(19) United States
(12) Patent Application Publication
(10) Pub. No.: US 2007/0213102 A1
(43) Pub. Date: Sep. 13, 2007

(54) Lock for a portable communication device

(75) Inventor: Daljit S. Bedi, Mississauga (CA)

Correspondence Address: YOUNG & THOMPSON, 745 SOUTH 23RD STREET, 2ND FLOOR, ARLINGTON, VA, 22202, US

(73) Assignee: NAVREET KAINTH

(21) Appl. No.: 11/373,296

(22) Filed: Mar. 13, 2006

(51) Int. Cl. H04M 1/00

(52) U.S. Cl. 455/575.3

(57) ABSTRACT

A portable communication device includes a mechanism for opening the device. The communication device has two parts that pivot about a hinge between closed and open positions. The mechanism includes a spring that urges the two parts to the open position, and a lock that releasably locks the two parts in the closed position, where the lock includes a pin that is movable in a passageway that extends into the first and second parts, a resilient member that urges the pin into a locking position with the pin in both the first and second parts, and a depressible button at one longitudinal end of the hinge, where the button has an extension that extends into the passageway and pushes the pin into an unlocking position entirely within the second part when the button is depressed.

### BACKGROUND OF THE INVENTION

Some communication devices that are intended to be hand-carried and opened with one hand, such as “flip” phones, have two parts that pivot about a hinge between closed and open positions. The present invention is directed to an improvement for such devices, and more particularly to a mechanism for locking the two parts in the closed position and for easily unlocking the two parts so that they are movable to the open (operating) position.

Human engineering is an important aspect of the design of the mechanism that unlocks the two parts so that they move to an open position. The present invention seeks to improve this aspect of prior art locking mechanisms by positioning the lock so that it can easily be operated with the thumb when the device is held in the palm of the hand.

### SUMMARY OF THE INVENTION

An object of the present invention is to provide a novel mechanism for locking and unlocking two hinged parts that can be operated with the thumb when the device is held in the palm of the hand.

A further object of the present invention is to provide a novel mechanism for locking and unlocking two hinged parts that includes a button at one longitudinal end of the hinge that can be pushed with the thumb to open the two parts.

A yet further object of the present invention is to provide a novel lock for locking and unlocking two hinged parts, where the lock includes a pin that is movable in a passageway that extends into the first and second parts, a resilient member that urges the pin into a locking position with the pin in both the first and second parts, and a depressible button at one longitudinal end of the hinge, where the button has an extension that extends into the passageway and pushes the pin into an unlocking position entirely within the second part when the button is depressed.

A still further object of the present invention is to provide a novel portable communication device that includes this mechanism.

These and other objects and advantages of the invention will be apparent to those of skill in the art of the present invention after consideration of the following drawings and description of preferred embodiments.

### BRIEF DESCRIPTION OF THE DRAWINGS

FIGS. 1a and 1b show closed and opened positions of a portable communication device that includes the present invention.

FIG. 2 is an exploded pictorial representation of an embodiment of the present invention.

FIG. 3 is a cut-away pictorial representation of the assembled embodiment of FIG. 2.

FIGS. 4 and 5 are partial cut-away pictorial representations showing operation of the button of the lock of the present invention.

### DESCRIPTION OF PREFERRED EMBODIMENTS

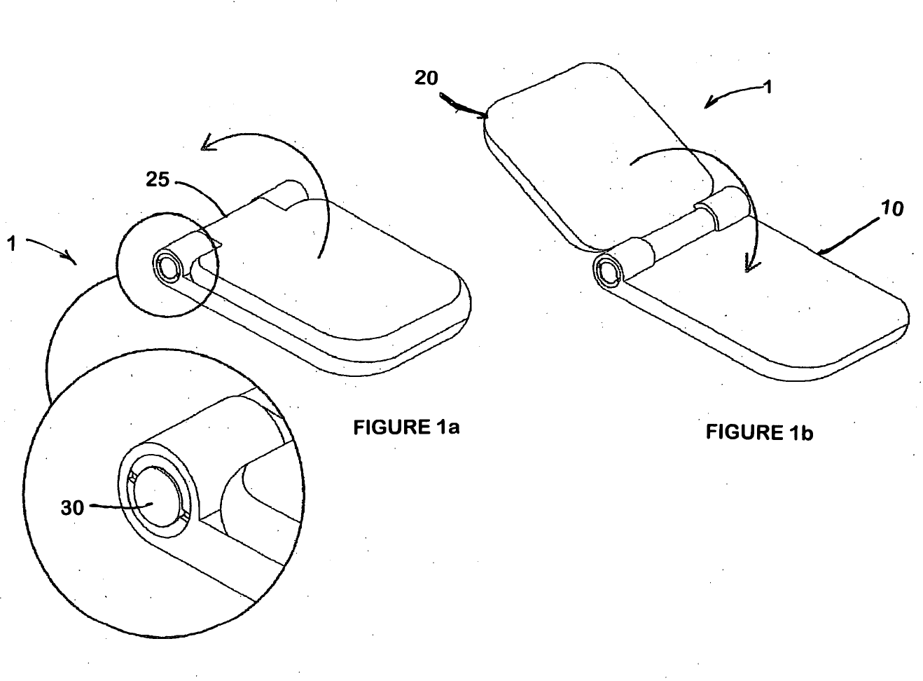

With reference now to FIGS. 1a and 1b, an embodiment of the present invention finds utility in a device 1 with two parts 10, 20 that are movable about a hinge 25 between a closed position (FIG. 1a) and an open, or operating, position (FIG. 1b). The mechanism of the present invention is a lock for locking and unlocking the two hinged parts 10, 20 that includes a button 30 at one longitudinal end of the hinge 25. As is apparent, the position of the button 30 at the end of the hinge permits operation of the button with the thumb when the device 1 is held in the palm of the hand. The drawings show the button 30 at the left end of the hinge, but of course the button may be on either end of the hinge.

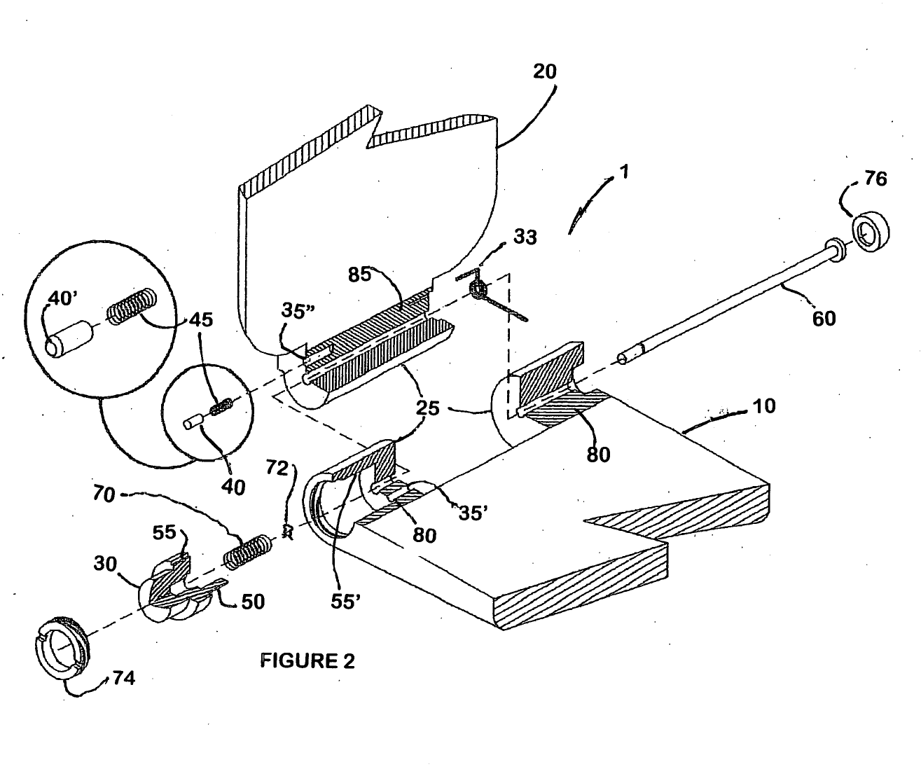

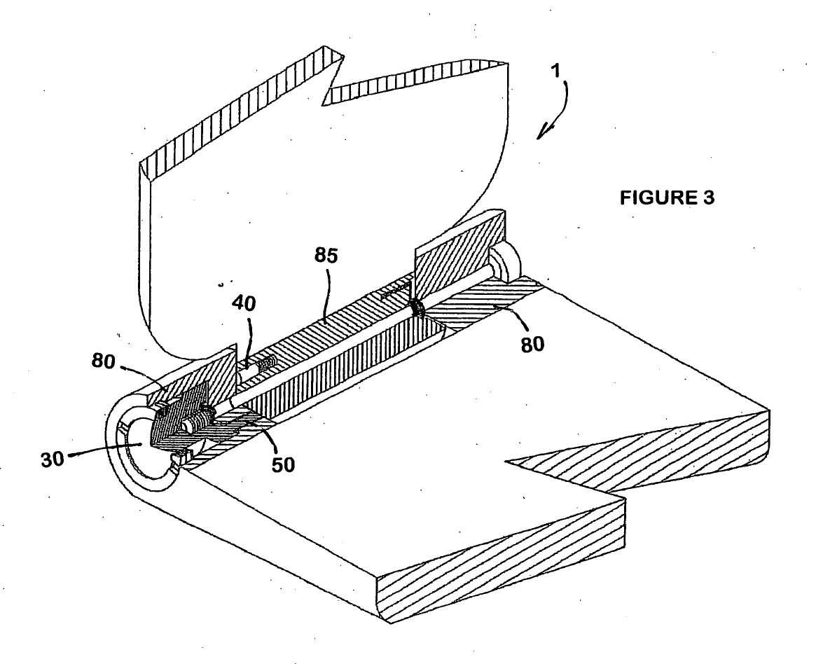

FIGS. 2 and 3 show an embodiment of the invention in exploded and assembled conditions. The device 1 may be a portable communication terminal where at least one of the first and second parts 10, 20 house communication electronics. The hinge 25 joins the first and second parts 10, 20 so that the two parts are movable between the open and closed positions. A spring 33 or similar resilient arrangement urges the first and second parts 10, 20 to the open position.

The lock includes a passageway 35 with a first section 35′ in the first part 10 and a second section 35″ in the second part 20. The first and second sections 35′ and 35″ are in registration when the first and second parts 10, 20 are in the closed position and not in registration when the first and second parts are in the open position. A pin 40 is movable in the passageway 35 between a locking position with the pin 40 in both the first and second sections 35′ and 35″ and an unlocking position with the pin 40 entirely within the second section 35″. A first resilient member 45 (e.g., coiled spring) urges the pin 40 into the locking position when the first and second parts 10, 20 are in the closed position and the first and second sections 35′ and 35″ are in registration. The button 30 is at one longitudinal end of the hinge 25 and has an extension 50 from an interior surface thereof. The extension 50 extends into the first section 35′ of the passageway and pushes the pin 40 into the unlocking position when the button 30 is depressed.

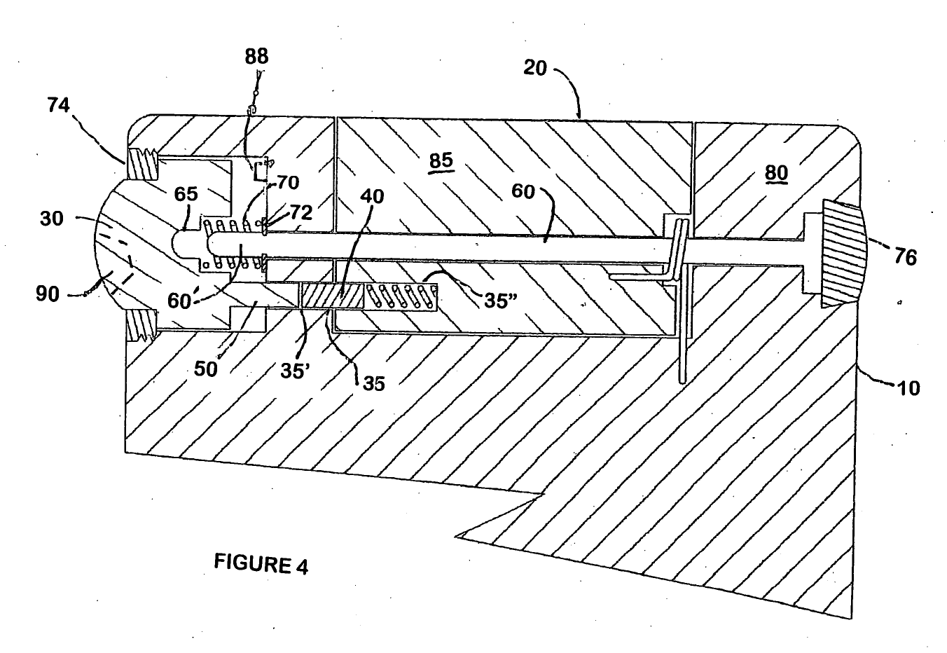

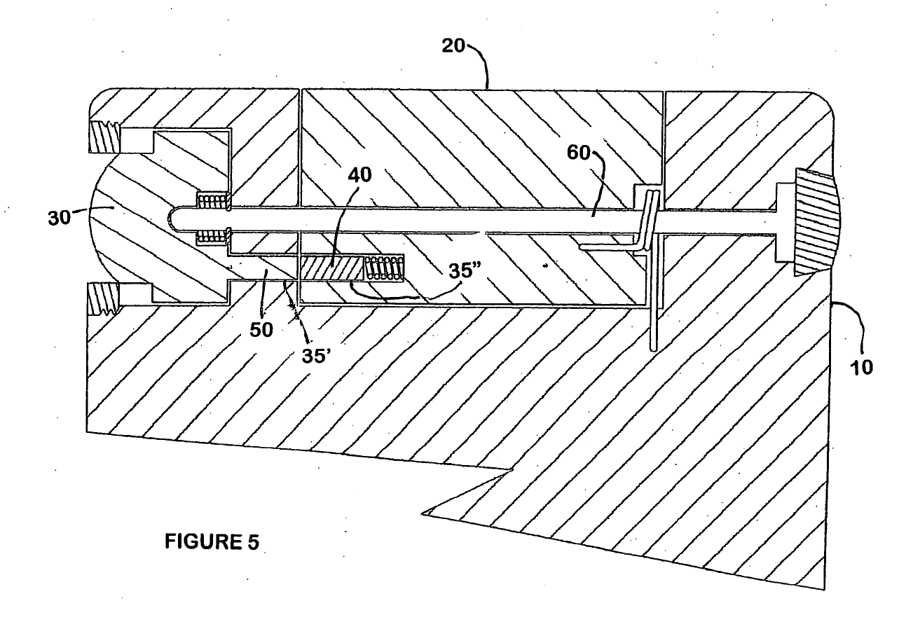

Operation of the button 30 may be clearly seen in FIGS. 4 and 5. FIG. 4 shows the pin 30 in the passageway 35 in the locking position with the pin 40 in both the first and second sections 35′ and 35″. FIG. 5 shows the pin 40 in the passageway 35 in the unlocking position with the pin 40 entirely within the second section 35″.

As shown in FIG. 5, it is preferable that the extension 50 has a length so that the extension 50 does not extend into the second section 35″ of the passageway 35 and so that the pin 40 is entirely within the second section 35″ when the button 30 is fully depressed.

One or more of the meeting ends of the depression 50 and the pin 40 may be rounded so that minor misalignment of the meeting ends relative to the gap between the first and second sections 35′ and 35″ does not jam the locking mechanism. The rounded end 40′ of the pin 40 is shown in the insert to FIG. 2.

With further reference to FIG. 2, a preferred embodiment of the invention provides that the button 30 and the first part 10 include complementary longitudinal concave/convex parts 55 and 55′ (such as tongue and groove fittings) that mesh to align the button 30 so that the extension 50 always is in registration with the first section 35′ of the passageway 35. These complementary parts 55, 55′ prevent rotation of the button 30 when the extension 50 is the first section 35′ to avoid damaging the extension 50.

As may be more clearly seen in FIG. 4, the hinge 25 may include a shaft 60 that extends through the first and second parts 10, 20. The button 30 may include a depression 65 that receives a distal end 60′ of the shaft 60. A second resilient member 70 may be provided to offer resistance against depression of the button 30. A cotter pin 72 may be provided to hold the shaft 60 in place longitudinally. A fitting 74 may be added to hold the button 30 in place and an end cap 76 may be added to the other end of the shaft.

In a yet more particular embodiment and with reference again to FIGS. 2-3, one end of the first part 10 may include two spaced apart hinge segments 80, where one of the hinge segments 80 is adapted to receive the button 30 and has the first section 35′ of the passageway 35 therein. A corresponding end of the second part 20 may include a continuous hinge segment 85 that is between the two spaced apart hinge segments 80 and that has the second section 35″ of the passageway 35 therein. The shaft 60 extends through an opening through the two spaced apart hinge segments 80 and the continuous hinge segment 85. The first and second sections 35′ and 35″ move into and out of registration with each other as the two parts 10, 20 move relative to each other about the shaft 60.

A depressible switch 88 for turning the device ON when the button is depressed may be provided adjacent to the button 30. A light 90 may also be provided.

While embodiments of the present invention have been described in the foregoing specification and drawings, it is to be understood that the present invention is defined by the following claims when read in light of the specification and drawings.

I claim:

1. A portable communication device with two parts that pivot about a hinge between closed and open positions, the device comprising a mechanism for opening and locking the two parts, said mechanism comprising:
a spring that urges the two parts to the open position;
a lock that releasably locks the two parts in the closed position, said lock including a pin that is movable in a passageway that extends into the first and second parts and a first resilient member that urges the pin into a locking position with the pin in both said first and second parts; and
a depressible button at one longitudinal end of said hinge, said button having an extension that extends into said passageway and pushes said pin into an unlocking position entirely within the second part when said button is depressed.

2. The portable communication device of claim 1, wherein said passageway has a first section in the first part and a second section in the second part, said first and second sections being in registration when the first and second parts are in the closed position and not in registration when the first and second parts are in the open position.

3. The portable communication device of claim 1, wherein said button and the first part comprise complementary longitudinal tongue and groove fittings that align said extension in registration with said passageway.

4. The device of claim 1, wherein said extension has a length so that said extension does not extend into the second part when said button is fully depressed.

5. The device of claim 1, wherein the hinge includes a shaft that extends through the first and second parts and wherein said button comprises a depression that receives a distal end of said shaft.

6. The device of claim 5, further comprising a second resilient member that resists depression of said button.

7. The device of claim 6, wherein an end of the first part comprises two spaced apart hinge segment, one of which is adapted to receive said button and has a first section of said passageway therein, and an end of the second part comprises a continuous hinge segment that is between said two spaced apart hinge segments and has a second section of said passageway therein, and wherein said shaft extends through an opening through said two spaced apart hinge segments and said continuous hinge segment.

8. A portable communication device, comprising:
a first part and a second part, at least one of said first and second parts housing communication electronics for the portable communication device;
a hinge joining said first and second parts, said first and second parts being pivotally movable about said hinge between a closed position with one of said first and second parts covering the other of said first and second parts and an open position;
a spring that urges said first and second parts to the open position;
a lock releasably locking said first and second parts in the closed position, said lock including a pin that is movable in a passageway that extends into said first and second parts parallel to and spaced from said hinge where said passageway extends into said second part a distance that is at least a length of said pin, and a resilient member that urges said pin into a locking position with part of said pin in said first part and part of said pin in said second part when said first and second parts are in the closed position; and
a depressible button at one longitudinal end of said hinge, said button having an extension that extends into said passageway in said first part and pushes said pin into an unlocking position entirely within said second part when said button is depressed.

9. The device of claim 8, wherein said button comprises a depression adjacent to said extension, said depression receiving a distal end of said hinge when said button is depressed.

10. The device of claim 8, further comprising a second resilient member on said hinge adjacent to said button that resists depression of said button.

11. The device of claim 8, wherein said extension has a length so that said extension does not extend into said second part when said button is fully depressed.

12. The device of claim 8, wherein an end of said first part comprises two spaced apart hinge segments, one of which is adapted to receive said button and has a first section of said passageway therein, and an end of said second part comprises a continuous hinge segment that is between said two spaced apart hinge segments and has a second section of said passageway therein, and wherein said hinge comprises a shaft that extends through an opening through said two spaced apart hinge segments and said continuous hinge segment.

13. The device of claim 12, wherein said first and second sections of said passageway are in registration when said first and second parts in the closed position.

14. The device of claim 8, wherein said button and said first part comprise complementary longitudinal concave/convex parts that align said extension in registration with said passageway.

15. A portable communication device, comprising:
a first part and a second part, at least one of said first and second parts housing communication electronics for the portable communication device;
a hinge joining said first and second parts, said first and second parts being pivotally movable about said hinge between a closed position with one of said first and second parts covering the other of said first and second parts and an open position;
a spring around said hinge that urges said first and second parts to the open position;
a lock releasably locking said first and second parts in the closed position, said lock including,
a passageway with a first section in said first part and a second section in said second part, said first and second sections being in registration when said first and second parts are in the closed position and not in registration when said first and second parts are in the open position,
a pin that is movable in said passageway between a locking position with said pin being in both said first and second sections and an unlocking position with said pin entirely within said second section, and
a first resilient member that urges said pin into the locking position when said first and second parts are in the closed position; and
a depressible button at one longitudinal end of said hinge, said button having an extension from an interior surface thereof, said extension extending into said first section of said passageway and pushing said pin into the unlocking position when said button is depressed.

16. The device of claim 15, wherein said hinge comprises a shaft that extends through said first and second parts and wherein said button comprises a depression that receives a distal end of said shaft.

17. The device of claim 16, further comprising a second resilient member around said distal end of said shaft that resists depression of said button.

18. The device of claim 16 wherein an end of said first part comprises two spaced apart hinge segments, one of which is adapted to receive said button and has said first section of said passageway therein, and an end of said second part comprises a continuous hinge segment that is between said two spaced apart hinge segments and has said second section of said passageway therein, and wherein said shalt extends through an opening through said two spaced apart hinge segments and said continuous hinge segment.

19. The device of claim 15, wherein said extension has a length so that said extension does not extend into said second section of said passageway when said button is fully depressed.

20. The device of claim 15, wherein said button and said first part comprise complementary longitudinal concave/convex parts that mesh to hold said button with said extension in registration with said first section of said passageway.
